(19) United States
(12) Patent Application Publication
(10) Pub. No.: US 2013/0054635 A1
(43) Pub. Date: Feb. 28, 2013

(54) PROCURING COMMUNICATION SESSION RECORDS

(71) Applicants: David E. PHELPS, Colorado Springs, CO (US); Brian S. Badger, Divide, CO (US); Phillip D. Crable, Woodland Park, CO (US); Chester Hamill, Colorado Springs, CO (US); Scott C. Danczuk, Colorado Springs, CO (US); John Macedo, Clearwater, FL (US)

(72) Inventors: David E. PHELPS, Colorado Springs, CO (US); Brian S. Badger, Divide, CO (US); Phillip D. Crable, Woodland Park, CO (US); Chester Hamill, Colorado Springs, CO (US); Scott C. Danczuk, Colorado Springs, CO (US); John Macedo, Clearwater, FL (US)

(73) Assignee: VERIZON PATENT AND LICENSING INC., Basking Ridge, NJ (US)

(21) Appl. No.: 13/220,951

(22) Filed: Aug. 30, 2011

(51) Int. Cl. G06F 15/16; G06F 17/30

(52) U.S. Cl. 707/769; 709/228; 707/E17.014

(57) ABSTRACT

A device may receive a session retrieval command corresponding to session metadata provided to a user via a user interface. The session retrieval command may include a request for session data corresponding to a communication session. The device may identify a first session service device, corresponding to the communication session, based on the session retrieval command, where the first session service device is to provide a first session service to communication sessions. The device may communicate with the first session service device to obtain a first set of session data corresponding to the communication session, generate a communication session record based on the first set of session data, and provide the communication session record to the user via the user interface.

### BACKGROUND

Currently available network technologies include networks that enable user devices to communicate in various ways, including calling, text messaging, and video conferencing. Operating such networks can involve implementing quality control practices or other types of network management practices to ensure that the network is operating properly. However, currently available technologies often do not provide adequate solutions for some network management practices, such as locating or retrieving call session records involving voice over Internet Protocol (voice over IP, VOIP) services and/or IP interactive voice response (IPIVR) services.

### BRIEF DESCRIPTION OF THE DRAWINGS

FIG. 1 is a diagram of an example overview of an implementation described herein;

FIG. 2 is a diagram of an example environment in which systems and/or methods, described herein, may be implemented;

FIG. 3 is a diagram of example components of a device of FIG. 2;

FIG. 4 is a diagram of example functional components of a record procurement device according to one or more implementations described herein;

FIG. 5 is a diagram of an example process for identifying communication session records according to one or more implementations described herein;

FIG. 6 is a diagram of an example process for procuring a communication session record according to one or more implementations described herein;

FIG. 7 is a diagram of an example system according to one or more implementations described herein;

FIG. 8 is a diagram of another example system according to one or more implementations described herein;

FIG. 9 is a sequence diagram of an example process for identifying communication session records according to one or more implementations described herein; and

FIG. 10 is a sequence diagram of an example process for procuring a communication session record according to one or more implementations described herein.

### DETAILED DESCRIPTION OF PREFERRED EMBODIMENTS

The following detailed description refers to the accompanying drawings. The same labels and/or reference numbers in different drawings may identify the same or similar elements.

In one or more implementations, described herein, devices may be used to procure communication session (e.g., call session) records. For example, a device may receive a session search command from a user via a user interface provided by the device. The session search command may include a query for session metadata corresponding to search parameters provided by the user. The device may communicate with a session metadata device to retrieve session metadata corresponding to the session search parameters, format the session metadata to represent one or more communication sessions, and provide the formatted session metadata to the user via the user interface.

The device may receive a session retrieval command corresponding to the session metadata provided to the user via a user interface. The session retrieval command may include a request for a communication session record corresponding to a communication session. The device may identify, based on the session metadata, one or more service devices that provided services to the communication session (e.g., a session setup device, a session IVR device, a session media device, etc.), and obtain session data from the one or more service devices. The device may generate a communication session record based on the session data and provide the communication session record to the user via the user interface. The communication session record may include a text-based record of the communication session.

As used herein, the term session metadata is intended to refer to any type of information, any variety of information, or any combination of information that may be described of data associated with, corresponding to, or otherwise relating to data corresponding to a communication session (also referred to herein as session data). For example, session metadata may include an IPIVR call identifier (which may include a unique identifier for an IPIVR call and any call legs associated therewith), a node identifier, a call start time, a call end time, an application identifier, and/or a network call identifier. Session metadata may also, or alternatively, include a call initiation type, a special sensitive information (SPI) indicator, an IPIVR host identifier, an exit application type, a uniform resource identifier (URI) corresponding to an inbound session initiation message, information stored in a to_header of a session initiation protocol (SIP) message, information stored in a from_header of a SIP message, and/or a p-asserted identity. Additionally examples of session metadata may include information stored in a called party field of a SIP message, information stored in a calling party field of a SIP message, a local call identifier assigned by an IVR service device, a call identifier corresponding to dialog between session service device (e.g., between an IVR service device and a session service device, a conference call identifier, a media server IP address or other session service device IP address, a leg start time, a call let start time, a call leg end time, and/or a SIP status relating to an IPIVR device.

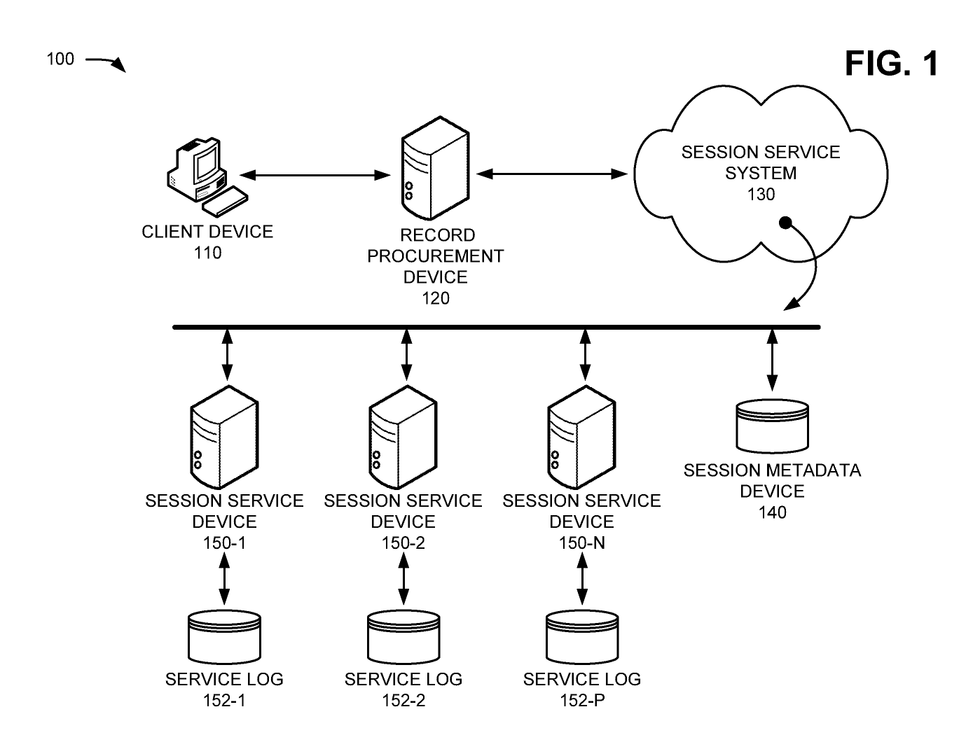

FIG. 1 is a diagram of an example overview 100 of an implementation described herein. As illustrated, overview 100 may include client device 110, record procurement device 120, and session service system 130 (which may include session metadata storage 140, session service devices 150-1, 150-2, . . . , 150-N (where N≧1) (collectively referred to as “session service devices 150,” and individually as “session service device 150”) and service logs 152-1, 152-2, . . . , 152-P (where P≧1) (collectively referred to as “service logs 152,” and individually as “service log 152”). In some implementations, the systems and devices of FIG. 1 may correspond to one or more systems or devices discussed elsewhere in this specification.

Client device 110 may include one or more of a variety of computing devices. For example, client device 110 may include a smart phone, a laptop computer, a tablet computer, a desktop computer, a virtual machine, or one or more other types of computing or communication devices. Client device 110 may enable a user of user device 110 to communicate with record procurement device 120 via a user interface.

Record procurement device 120 may include one or more of a variety of computing devices. For example, record procurement device 120 may include a desktop computer, a virtual machine, a server, a cluster of servers, or one or more other types of computing or communication devices. In implementations where record procurement device 120 includes multiple devices, the devices may be located in a single geographic location or multiple geographic locations. In some implementations, record procurement device 120 may be implemented as a web server with one or more scripts for performing operations and providing communication services discussed herein.

Session service system 130 may include one or more networks, devices, functions, or applications capable of supporting communication sessions or providing communication services. For example, session service system 130 may include an IPIVR system in an IP multimedia subsystem (IMS) network. Some implementations, described herein, may include multiple session service systems 130, and record procurement device 120 may be capable of identifying which session service systems 130 provided services to communication sessions corresponding to one or more session search parameters provided by a user. As depicted, session service system 130 may include a session metadata storage 140, session service device 150, and service logs 152.

Session metadata storage 140 may include one or more computing devices and/or storage devices. For example, session metadata storage 140 may include a desktop computer, a virtual machine, a server, a cluster of servers, or one or more other types of computing or communication devices. Session metadata storage 140 may include a repository of metadata corresponding to one or more communication sessions. In some implementations, session metadata storage 140 is accessible by record procurement device 120, and the metadata stored by session metadata storage 140 may be received from one or more of session service devices 150. In some implementations, the metadata stored by session metadata storage 140 may describe communication sessions supported by session service system 130.

Session service device 150 may include one or more of a variety of computing devices. For example, session service device 150 may include a desktop computer, a virtual machine, a server, a cluster of servers, or one or more other types of computing or communication devices. In implementations where session service device 150 includes multiple devices, the devices may be located in a single geographic location or in multiple geographic locations.

In some implementations, session service device 150 may provide one or more types of session services (e.g., call setup services, call IVR services, call media services, etc.) and/or maintain a log or other type of repository of session data corresponding to the session services provided. For example, session service device 150 may include one or more session setup devices that maintain a log, a database, or another type of repository (e.g., service log 152) of session setup data SIP messages corresponding to communication sessions. As another example, session service device 150 may also, or alternatively, include a session IVR device that maintains a log, a database, or another type of repository (e.g., service log 152) of session IVR data (e.g., IPIVR data) corresponding to communication sessions. In yet another example, session service device 150 may include a media device that maintains a log, a database, or another type of repository (e.g., service log 152) of session media data (e.g., audio files) corresponding to communication sessions.

In some implementations, a session setup device may provide one or more of a variety of network services relating session service system 130. For example, session setup device may operate as an ingress point and/or an egress point for call session communications entering or exiting session service system 130. Session setup device may also, or alternatively, generate billing records or other information based on, for example, network usage. In certain implementations, a session setup device may provide load balancing services, which may include resource brokering services, to help ensure that session service system 130 is not overloaded with calls and that resources are distributed appropriately. As mentioned above, session setup device may also, or alternatively, maintain one or more transaction detail records (TDRs) (e.g., a TDR log), in addition to session assisting with the maintenance of information stored in session metadata device 140.

By contrast, session IVR device may provide call session services relating interactive voice response services. For instance, session IVR device may provide automated interactions with a user of a user device, prompt the user to enter information, provide customized responses to the user based on information submitted by the user, and one or more other types of interactive services. In some implementations, session IVR device may also provide session routing services. For example, a session IVR device may determine whether a call session should be recorded and operated to create a session routing path that traverses a session recording system. Session IVR device may also, or alternatively, cooperate with a session media device to enable or enhance system IVR services or other types of media-related services. A session IVR device may log session data corresponding to an IVR portion of a call session. In some implementations, session IVR device may log data for each call leg, which may occur at the beginning of a leg and updated at or near the end of a leg. In certain implementations, session IVR device may provide session IVR data to recording procurement device 120 in response to receiving a request from record procurement device.

A session media device may provide media-related services to a call session. For example, session media device may provide session IVR device with media content for interacting with network subscribers. Session media device may log SIP call data. In some implementations, session media device may also, or alternatively, receive requests from record procurement device 120 and respond by providing a proper media server log file

In some implementations, SPI data may be received by one or more of session service devices 150. For example, session setup device and session IVR device may receive In some implementations, while a TDR log may not include any SPI data and session IVR device may be periodically cleared of SPI data, at times, a media device service log may be combined with a TDR log to reveal SPI data. Accordingly, a media server log may be suppressed if an application attempting to collect session information is flagged as an application that collects SPI data.

In light of the above, one or more implementations, described herein, enable a user or operator of client device 110 to retrieve session metadata that describe one or more communication sessions, select one or more of the communication sessions, and obtain communication session records derived from operationally distinct devices that are, nevertheless, capable of cooperating to support communication sessions, log session data, and provide the session data so that a communication session record may be generated.

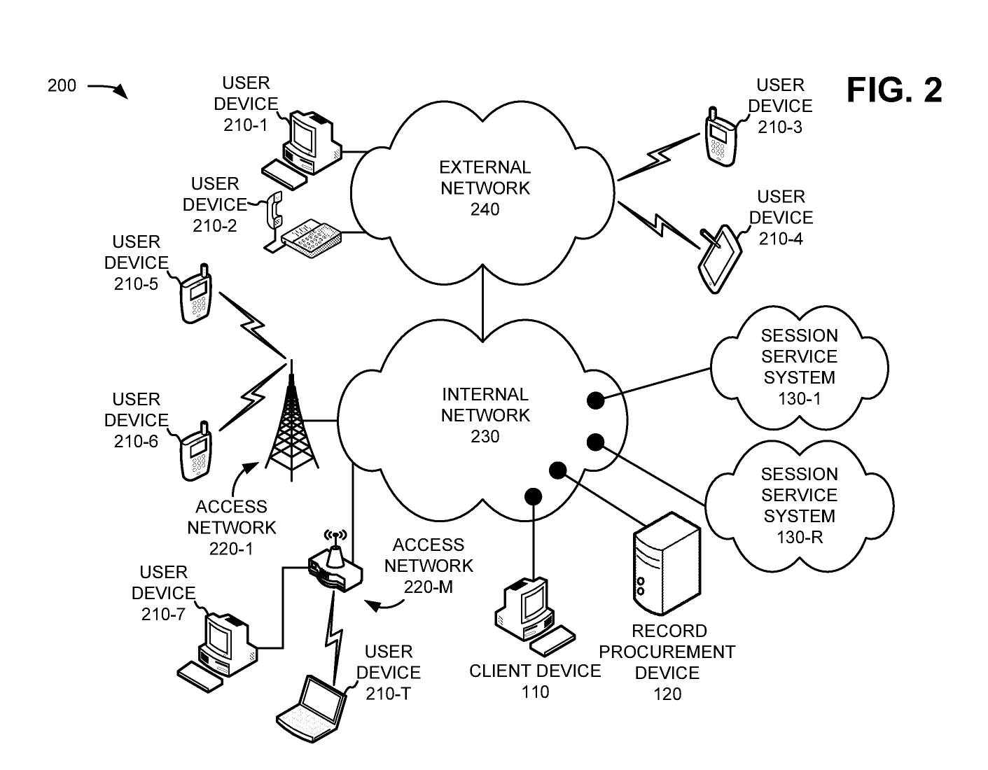

FIG. 2 is a diagram of an example environment 200 in which systems and/or methods, described herein, may be implemented. As depicted, environment 200 may include client device 110, record procurement device 120, session service systems 130-1, . . . , 130-R (where R≧1) (collectively referred to as “session service systems 130,” and individually as “session service system 130”), user devices 210-1, 210-2, 210-3, 210-4, 210-5, 210-6, 210-7, . . . , 210-T (where T≧1) (collectively referred to as “user devices 210,” and individually as “user device 210”), access networks 220-1, . . . , 220-M (where M≧1) (collectively referred to as “access networks 220,” and individually as “access network 220”), internal network 230, and external network 240. While FIG. 2 shows a particular number and arrangement of networks and devices, in alternative implementations, environment 200 may include additional networks or devices, fewer networks or devices, different networks or devices, or differently arranged networks or devices than those depicted in FIG. 2.

Client device 110, record procurement device 120, and session service system 130 are discussed above with reference to FIG. 1. User device 210 may include one or more of a variety of computing devices. For example, user device 210 may include a smart phone, a laptop computer, a tablet computer, a desktop computer, or one or more other types of computing or communication devices. User device 210 may communicate with one or more other user devices 210 via access network 220, internal network 230, and/or external network 240. User device 210 may also, or alternatively, communicate with one or more network devices of access network 220, internal network 230, and/or external network 240. In some implementations, user device 210 may communicate with other user devices 210 and/or network devices using a packet-based communication technology, such as VOIP technology.

Access network 220 may include any type of network or combination of networks. For example, access network 220 may include a local area network (LAN) (e.g., an Ethernet network), a wireless LAN (WLAN) (e.g., an IEEE 802.11x network), a wide area network (WAN) (e.g., the Internet), or a wireless WAN (WWAN) (e.g., a Long-Term Evolution (LTE) network, a High-Speed Packet Access (HSPA) network, an Evolved High Rate Packet Data (eHRPD) network, etc). Access network 220 may also, or alternatively, include a fiber optic (e.g., a fiber optic service (FiOS)) network, a metropolitan area network (MAN), an ad hoc network, a telephone network (e.g., a Public Switched Telephone Network (PSTN)), a virtual network (e.g., a virtual private network (VPN)), and/or a VOIP network. In some implementations, access network 220 may be capable of enabling user devices 210 to communicate with, or otherwise obtain services from, internal network 230.

Internal network 230 may include any type of network or combination of networks. For instance, internal network 230 may include a LAN, a WLAN, a WAN, or a WWAN. Additionally, or alternatively, internal network 230 may include a fiber optic network, a MAN, an ad hoc network, a telephone network, a virtual network, or a VOIP network. Internal network 230 may be capable of supporting communication sessions or providing communication services. For example, internal network 230 may provide subscriber registration services, subscriber authentication services, subscriber authorization services, call session control services, billing services, and/or other types of network services. In some implementations, internal network 230 may include an IP multimedia subsystem (IMS) network, a code division multiple access (CDMA) network, and/or another type of network capable of supporting communication sessions or otherwise providing network services.

Similar to internal network 230, external network 240 may include any type of network or combination of networks. For instance, external network 240 may include a LAN, a WLAN, a WAN, and/or a WWAN. External network 240 may include a fiber optic network, a MAN, an ad hoc network, a telephone network, a virtual network, and/or a VoIP network. In some implementations, external network 240 may include the Internet.

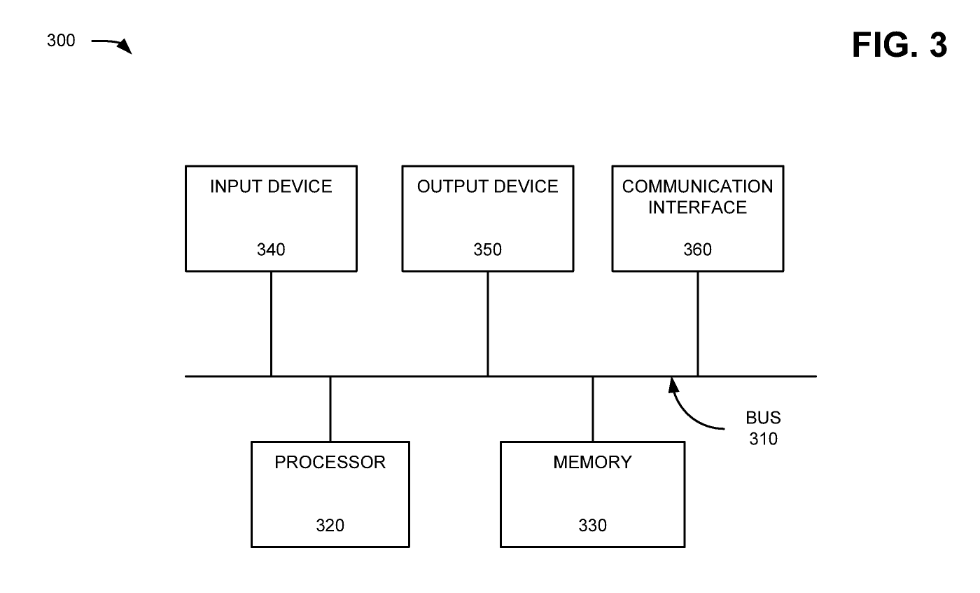

FIG. 3 is a diagram of example components of a device 300 that may operate within the environment of FIG. 2. For example, device 300 may correspond to client device 110, record procurement device 120, session service device 150 (e.g., a session setup device, an IVR device, a media device, etc.), session metadata storage 140, and user device 210. Each of device 110, record procurement device 120, session service device 150, session metadata storage 140, and user device 210.

As depicted, device 300 may include bus 310, processor 320, memory 330, input device 340, output device 350, and communication interface 360. However, in other implementations, device 300 may include fewer components, additional components, different components, or differently arranged components than those illustrated in FIG. 3.

Bus 310 may include one or more component subsystems and/or communication paths that enable communication among the components of device 300. Processor 320 may include one or more processors, microprocessors, data processors, co-processors, network processors, application-specific integrated circuits (ASICs), controllers, programmable logic devices (PLDs), chipsets, field-programmable gate arrays (FPGAs), or other types of components that may interpret or execute instructions or data. Processor 320 may control the overall operation, or a portion thereof, of device 300, based on, for example, an operating system and/or various applications. Processor 320 may access instructions from memory 330, from other components of device 300, or from a source external to device 300 (e.g., a network or another device).

Memory 330 may include memory and/or secondary storage. For example, memory 330 may include random access memory (RAM), dynamic RAM (DRAM), read-only memory (ROM), programmable ROM (PROM), flash memory, or some other type of memory. Memory 330 may include a hard disk (e.g., a magnetic disk, an optical disk, a magneto-optic disk, a solid state disk, etc.) or some other type of computer-readable medium, along with a corresponding drive. A computer-readable medium may be defined as a non-transitory memory device. A memory device may include space within a single physical memory device or spread across multiple physical memory devices.

Input device 340 may include one or more components that permit a user to input information into device 300. For example, input device 340 may include a keypad, a button, a switch, a knob, fingerprint recognition logic, retinal scan logic, a web cam, voice recognition logic, a touchpad, an input port, a microphone, a display, or some other type of input component. Output device 350 may include one or more components that permit device 300 to output information to a user. For example, output device 350 may include a display, light-emitting diodes (LEDs), an output port, a speaker, or some other type of output component.

Communication interface 360 may include one or more components that permit device 300 to communicate with other devices or networks. For example, communication interface 360 may include some type of wireless or wired interface. Communication interface 330 may also include an antenna (or a set of antennas) that permit wireless communication, such as the transmission and reception of radio frequency (RF) signals.

As described herein, device 300 may perform certain operations in response to processor 320 executing software instructions contained in a computer-readable medium, such as memory 330. The software instructions may be read into memory 330 from another computer-readable medium or from another device via communication interface 360. The software instructions contained in memory 330 may cause processor 320 to perform one or more processes described herein. Alternatively, hardwired circuitry may be used in place of, or in combination with, software instructions to implement processes described herein. Thus, implementations described herein are not limited to any specific combination of hardware circuitry and software.

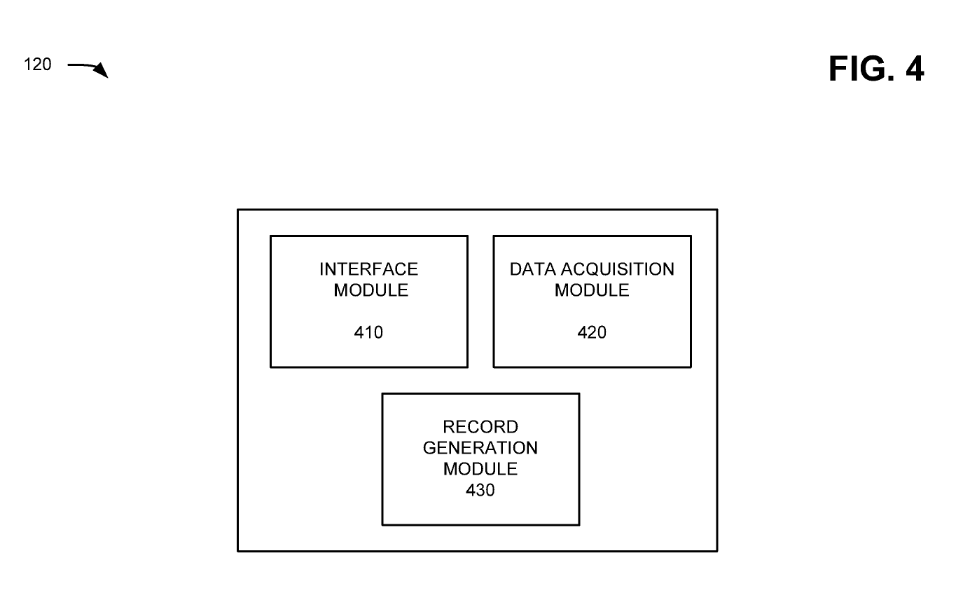

FIG. 4 is a diagram of example functional components of record procurement device 120 according to one or more implementations described herein. As illustrated, record procurement device 120 may include interface module 410, data acquisition module 420, and record generation module 430. Depending on the implementation, one or more of modules 410-430 may be implemented as a combination of hardware and software based on the components illustrated and described with respect to FIG. 3. Alternatively, modules 410-430 may each be implemented as hardware based on the components illustrated and described with respect to FIG. 3.

Interface module 410 may provide functionality relating to communicating with a user. For example, interface module 410 may enable record procurement device 120 to provide a user with an interface for providing information to the user, prompting the user to input information, enabling the user to input information, and/or receiving information from the user. Information passed between record procurement device 120 and a user may include a wide variety of information, including commands, requests, prompts, notifications, queries, or one or more other types of information relating to communication session records. In some implementations, the user may communicate with record procurement device 120 remotely. In other implementations, the user may communicate with record procurement device 120 locally. In certain implementations, record procurement device 120 may be capable of communicating with, and providing services to, multiple client devices 110.

Interface module 410 may enable record procurement device 120 to receive session search commands and/or record retrieval commands from a user. A session search command may include a request to identify one or more communication sessions corresponding to session search parameters provided by the user. A session search command may include a variety of information, including one or more session search parameters.

A session search parameter may include one or more types of data corresponding to, or associated with, one or more communication sessions. Examples of session search parameters may include a session identifier, a network node identifier, a session start time, a session end time, an application identifier, a network session identifier, a source node identifier (e.g., an identifier of a calling device), a destination node identifier (e.g., an identifier of a called device), a session initiation type, an IVR device identifier, a session exit type, a resource identifier, a selected portion of a protocol message, a session leg identifier, or one or more other types of data relevant to identifying communication sessions.

Interface module 410 may also, or alternatively, enable record procurement device 120 to receive record retrieval commands from a user. A record retrieval command may include a request for a communication session record corresponding to a communication session. In some implementations, a record retrieval command may include a user selecting a particular communication session, from multiple communication sessions, represented by session metadata in a user interface.

Data acquisition module 420 may provide functionality relating to obtaining information from other devices. For example, data acquisition module 420 may enable record procurement device 120 to communicate with session metadata storage 140 to obtain session metadata. In another example, data acquisition module 420 may enable record procurement device 120 to communicate with session service device 150 to obtain session data corresponding to, or associated with, a communication session. In implementations that include multiple session service systems 130, data acquisition module 420 may enable record procurement device 120 to communicate with one or more session service devices 150 to identify which session service systems 130 provided services for a particular communication session.

Data acquisition module 420 may cooperate with interface module 410 to format session metadata according to a preselected format and present the metadata to a user via a user interface. In certain implementations, a user may select a communication session represented by the session metadata to request a communication session record corresponding to the communication session. In some implementations, a user selecting a communication session may cause record procurement device 120 to retrieve session data from one or more session service devices 150. The session data may be stored in one or more service logs 152 maintained by session service devices 150.

Record generation module 430 may provide functionality relating to generating communication session records. For example, record generation module 430 may enable record procurement device 120 to compile, assemble, derive, or otherwise produce a record of a communication session based on session data obtained from one or more session service devices 150. In some implementations, record generation module 430 may also, or alternatively, cooperate with user interface device 410 to provide a formatted communication session record to a user via a user interface or some other type of communication interface.

In addition to the functionality described above, functional components 400 may also, or alternatively, provide functionality as described elsewhere in this specification. While FIG. 4 shows a particular number and arrangement of modules, in alternative implementations, functional components 410-430 may include additional modules, fewer modules, different modules, or differently arranged modules than those depicted.

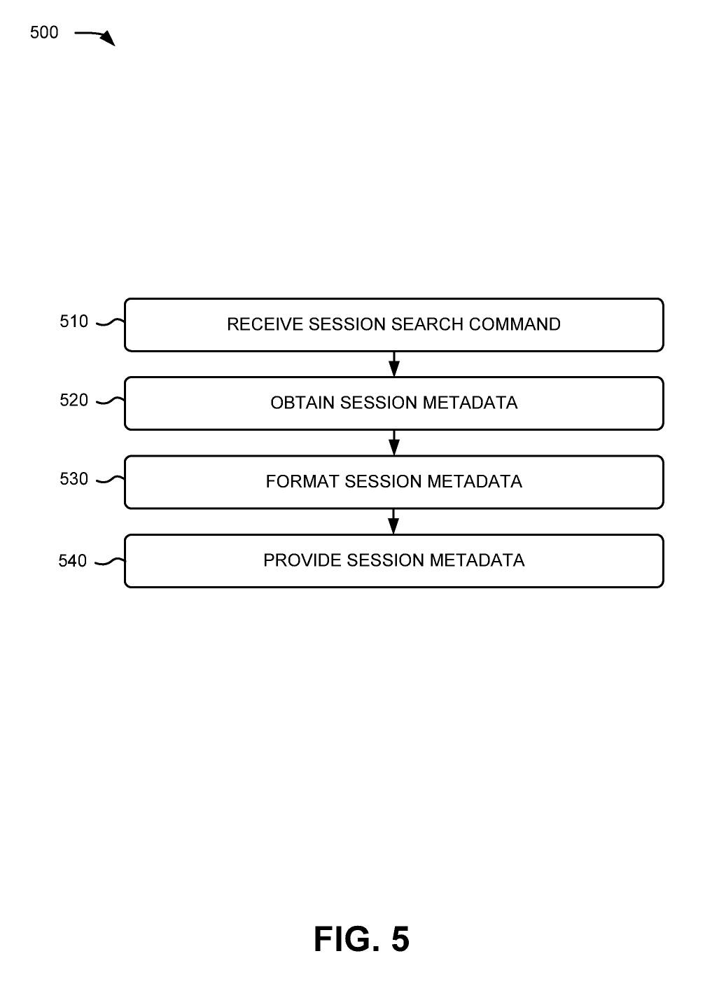

FIG. 5 is a diagram of an example process 500 for identifying communication session records according to one or more implementations described herein. In one or more implementations, process 500 may be performed by one or more components of record procurement device 120. In other implementations, one or more blocks of process 500 may be performed by one or more other components/devices, or a group of components/devices, including or excluding record procurement device 120.

A session search command may be received (block 510). For example, record procurement device 120 may receive a session search command from a user of client device 110 via a user interface. The session search command may include one or more session search parameters, such as a session identifier, a network node identifier, a session start time, a session end time, an application identifier, a network session identifier, or one or more other types of data relevant to identifying communication sessions.

Session metadata may be obtained (block 520). For example, record procurement device 120 may communicate with session metadata storage 140 to retrieve a set of session metadata corresponding to one or more session search parameters. In implementations with multiple session service systems 130, record procurement device 120 may communicate with session metadata devices 140 corresponding to each session service system 130 to obtain session metadata.

The metadata returned by session metadata storage 140 may depend on the session search parameters provided by a user. For example, if the session search parameters are broadly applicable to communication sessions (e.g., a call date), session metadata storage 140 may return session metadata corresponding to multiple communication sessions. If the session search parameters are relatively specific (e.g., a call date, a calling identifier, and a called identifier), session metadata storage 140 may return session metadata corresponding to a few communication sessions. If the session search parameters uniquely describe a communication session (e.g., a session identifier), session metadata storage 140 may return metadata corresponding to one communication session. If the session search parameters do not correspond to any communication sessions serviced by session service system 130, session metadata storage 140 may not return session metadata for any communication sessions.

Session metadata may be formatted (block 530). For example, record procurement device 120 may arrange and/or modify session metadata according to a pre-selected format. In some implementations, the pre-selected format may include describing communication sessions using the session metadata and/or arranging the communication sessions in chronological order, or in another manner that may enable a user to efficiently and accurately evaluate communication sessions when the session metadata is provided to the user (block 540). In contrast to raw or unformatted metadata (e.g., log data), formatting session metadata may better enable a user to review and understand which communication session records are available and to properly identify one or more communication session records of interest, especially in scenarios involving large quantities of session metadata and/or large quantities of communication session records.

While FIG. 5 shows a flowchart diagram of an example process 500 for identifying communication session records, in other implementations, a process for identifying communication session records may include fewer operations, different operations, differently arranged operations, or additional operations than depicted in FIG. 5.

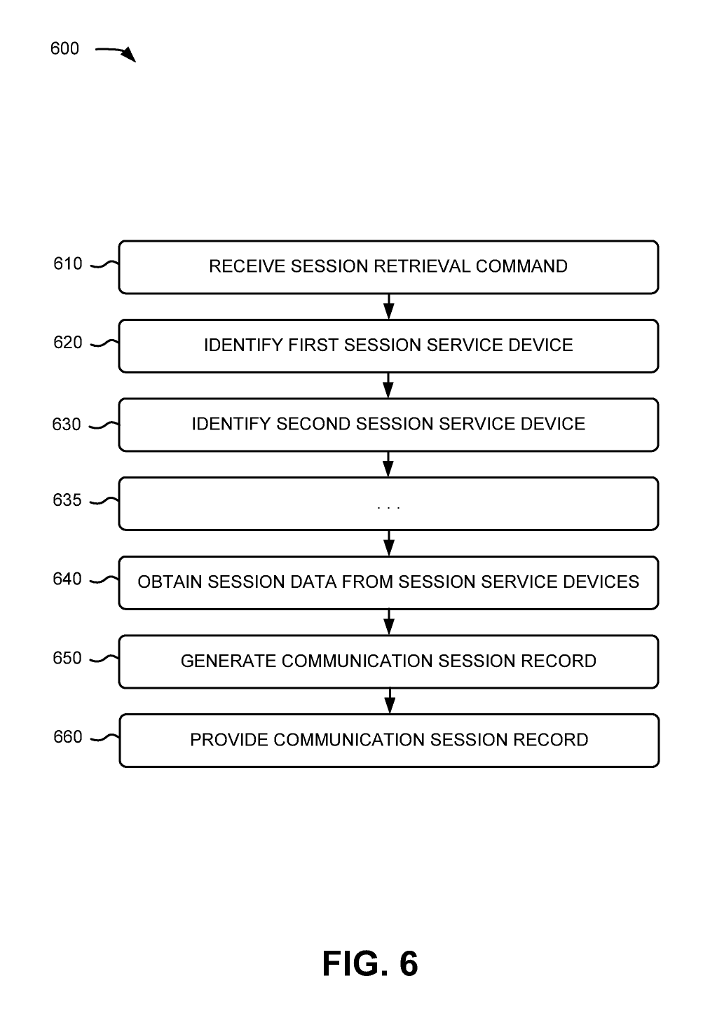

FIG. 6 is a diagram of an example process 600 for procuring a communication session record according to one or more implementations described herein. In one or more implementations, process 600 may be performed by one or more components of record procurement device 120. In other implementations, one or more blocks of process 600 may be performed by one or more other components/devices, or a group of components/devices, including or excluding record procurement device 120.

A session retrieval command may be received (block 610). For example, record procurement device 120 may receive a message, originating from a user, to retrieve, receive, or otherwise obtain a communication session record corresponding to a communication session. In some implementations, a session retrieval command may correspond to session metadata previously provided to the user. For example, record procurement device 120 may use session metadata to represent one or more communication sessions in a user interface, and a user may submit a session retrieval command by selecting one or more of the represented communication sessions.

A first session service device may be identified (block 620). For example, record procurement device 120 may identify a session service device 150 that provided support or services during a communication session identified in a session retrieval command. In some implementations, record procurement device 120 may identify session service device 150 based on session metadata. For instance, as discussed above, session metadata may be used to represent a communication session corresponding to session search parameters provided by a user. In certain implementations, session metadata may also, or alternatively, be used to identify one or more session service devices 150 (e.g., a session setup device, a session IVR device, a session media device, etc.) that provided services for a communication session. In a similar manner, a second session service device 150 (e.g., a session IVR device) may be identified (block 630), a third session service device 150 (e.g., a session media device) may be identified (block 635), and one or more additional session service devices 150 that provided support or services for the communication session may be identified (also block 635).

Session data corresponding to a communication session may be obtained (block 640). For example, record procurement device 120 may communicate with session service device 150 (e.g., a session setup device, a session IVR device, a session media device, etc.) to obtain session data corresponding a communication session. In some implementations, session data received from to a session service device 150 may correspond to a particular aspect of a communication session and/or a session service provided by the session service device 150.

For example, session procurement device 120 may obtain session setup data from one session service device 150, session IVR data from another session service device 150, and session media data from yet another session service device 150. In such implementations, the session service device 150 providing the session setup data may be the session service device 150 that operated as an ingress/egress for signaling messages used to setup the communication session. Also in such implementations, the session service device 150 providing the session IVR data may be the session service device 150 that provided session IVR services for the communication session, and the session service device 150 providing the session media data may be the session service device 150 that provided session media service for the communication session. In other implementations, the session service device 150 providing the session data may be a different session service device 150 than the session service device 150 that provided the session services.

A communication session record may be generated (block 650). For example, record procurement device 120 may compile, concatenate, derive, or otherwise produce a record of a communication session based on session data obtained from one or more session service devices 150. In some implementations, the communication session record may be a complete record of an entire communication session.

A communication session record may be provided (block 660). For example, record procurement device 120 may provide, to a user, data representing, or otherwise corresponding to, a communication session. In some implementations, record procurement device 120 may provide the communication session record to the user via a user interface. Additionally, or alternatively, record procurement device 120 may provide the communication session record to a device, such as client device 110, that is being operated by the user.

While FIG. 6 shows a flowchart diagram of an example process 600 for procuring a communication session record, in other implementations, a process for procuring a communication session record may include fewer operations, different operations, differently arranged operations, or additional operations than depicted in FIG. 6.

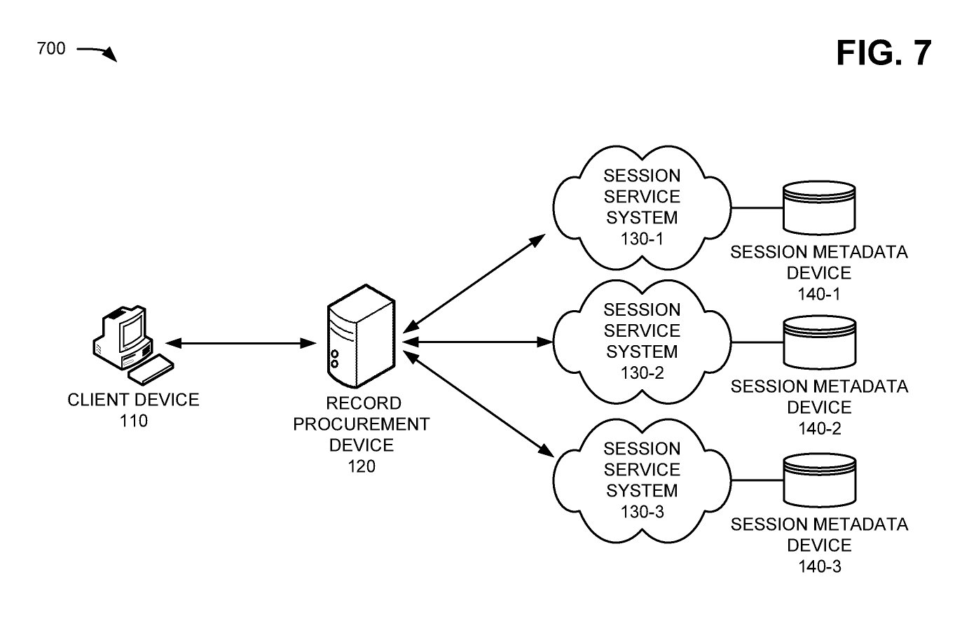

FIG. 7 is a diagram of an example system 700 according to one or more implementations described herein. System 700 may include client device 110, record procurement device 120, session service systems 130, and session metadata devices 140. Client device 110, record procurement device 120, session service system 130, and session metadata storage 140 are each discussed above.

In the example of FIG. 7, session service systems 130 may each include a session metadata device 140 that operates as a repository (e.g., a log, a table, a database, etc.) for session metadata. In some implementations, the session metadata stored by session metadata device 140 may be received from the corresponding session service system 130. For instance, in some implementations, a session IVR device, or one or more other types of session service devices 150, may transmit session metadata, corresponding to communication sessions serviced by the session IVR device, to a local session metadata device 140. As described above, the session metadata may be queried by record procurement device 120 in response to session search requests from client device 110. In addition to being descriptive of a communication session, the session metadata may also include a session service system identifier, and/or one or more other types of identifiers, so that record procurement device 120 may map the session metadata to the corresponding session service system 130.

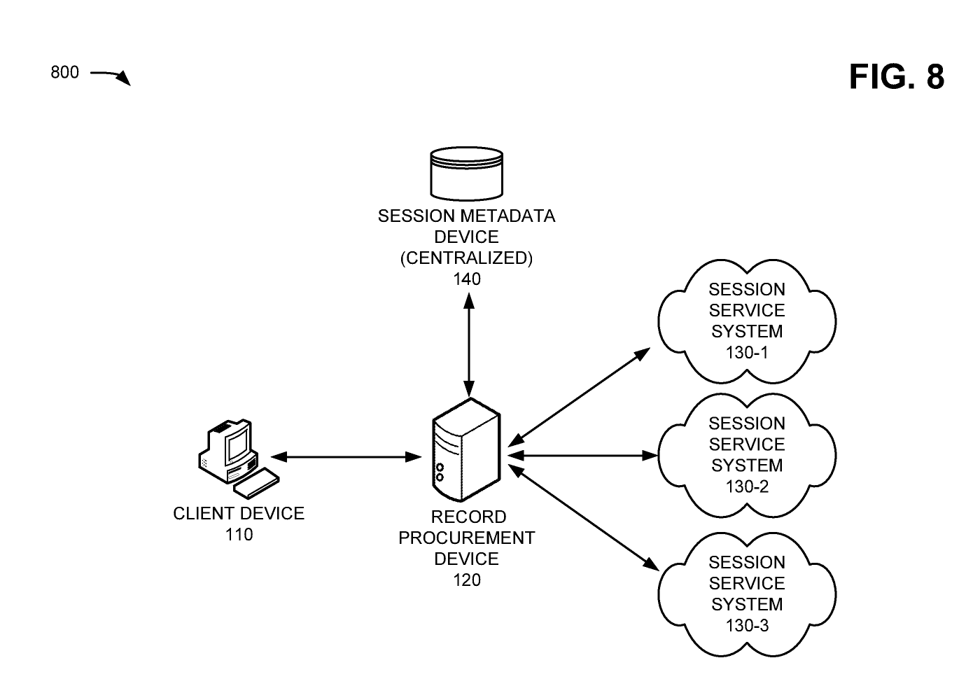

FIG. 8 is a diagram of another example system 800 according to one or more implementations described herein. Similar to system 700 of FIG. 7, system 800 may include client device 110, record procurement device 120, session service systems 130, and session metadata device 140. Client device 110, record procurement device 120, session service system 130, and session metadata storage 140 are each discussed above.

In the example of FIG. 8, none of session service systems 130 includes a session metadata device 140. Instead, system 800 includes a centralized session metadata device 140 that operates as a centralized repository (e.g., a log, a table, a database, etc.) for session metadata. The session metadata stored by centralized session metadata device 140 may be received from each session service system 130. For instance, in some implementations, a session IVR device, or one or more other types of session service devices 150, may transmit session metadata, corresponding to communication sessions serviced by the session IVR device, to centralized session metadata storage 140. The session metadata may be queried by record procurement device 120 in response to session search requests from client device 110. In addition to being descriptive of a communication session, the session metadata may also include a session service system identifier, and/or one or more other types of identifiers, so that record procurement device 120 may map the session metadata to the corresponding session service system 130.

In one or more implementations consistent with system 700 of FIG. 7, providing session metadata device 140 for each session service system 130 may reduce overall network traffic by avoiding the need to transmit data (e.g., session metadata) across the network to a centralized location. However, providing session metadata device 140 for each session service system 130 may increase the time required for record procurement device 120 to search for relevant session metadata. By contrast, providing a centralized session metadata device 140, as illustrated in FIG. 6, may reduce the time required by record procurement device 120 to obtain session metadata; however, requiring each session service system 130 to transmit data (e.g., session metadata) to a remote location may contribute to network congestion.

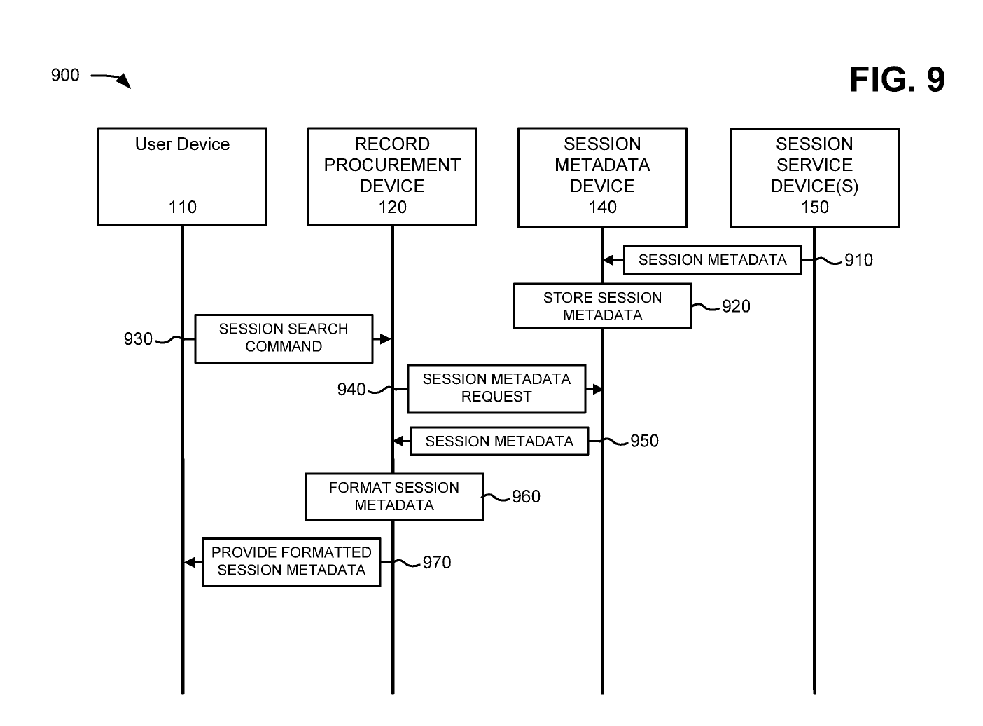

FIG. 9 is a sequence diagram of an example process 900 for identifying communication session records according to one or more implementations described herein. In one or more implementations, process 900 may be performed by one or more components of user device 110, record procurement device 120, session metadata device 140, and/or session service devices 150. In other implementations, one or more blocks of process 900 may be performed by one or more other components/devices, or a group of components/devices, including or excluding record user device 110, record procurement device 120, session metadata device 140, and/or session service device 150.

One or more session service devices 150 may communicate session metadata to session metadata device 140 (block 910), and the session metadata may be stored by session metadata device 140 (block 920). As mentioned above, session services devices 150 may include one or more of a variety of network devices that may participate in providing network services to communication sessions (e.g., a session setup device, a session IVR device, a session media device, etc.). As described above, session metadata may include a variety of information corresponding to a communication session.

At some point, user device 110 may communicate a session search command to record procurement device 120 (block 930), and record procurement device 120 may communicate a session metadata request (block 940) to session metadata device 140 (block 940). The session search command may include one or more session search parameters corresponding to one or more communication sessions that an operator of user device 110 may be interested in. Similarly, the session metadata request may include a query for session metadata that corresponds to the session search parameters received from user device 110.

Session metadata device 140 may respond to the session metadata request by communicating session metadata corresponding to session search parameters in the session metadata request (block 950). Record procurement device 120 may format the session metadata (block 960), and provide the formatted session metadata to user device 110 (block 970). As mentioned above, the session metadata may be formatted according to various arrangements. For example, the session metadata may be formatted chronologically by communication session or according to one or more other types of formatting arrangements. Additionally, or alternatively, the session metadata may be formatted into lists, drop down menus, selectable interface objects, and/or one or more other types of interface objects and/or arrangements to enable an operator of user device 110 to review the session metadata efficiently.

While FIG. 9 shows a sequence of an example process 900 for identifying communication session records, in other implementations, a process for identifying communication session records may include fewer devices or operations, different devices or operations, differently arranged devices or operations, or additional devices or operations than depicted in FIG. 9.

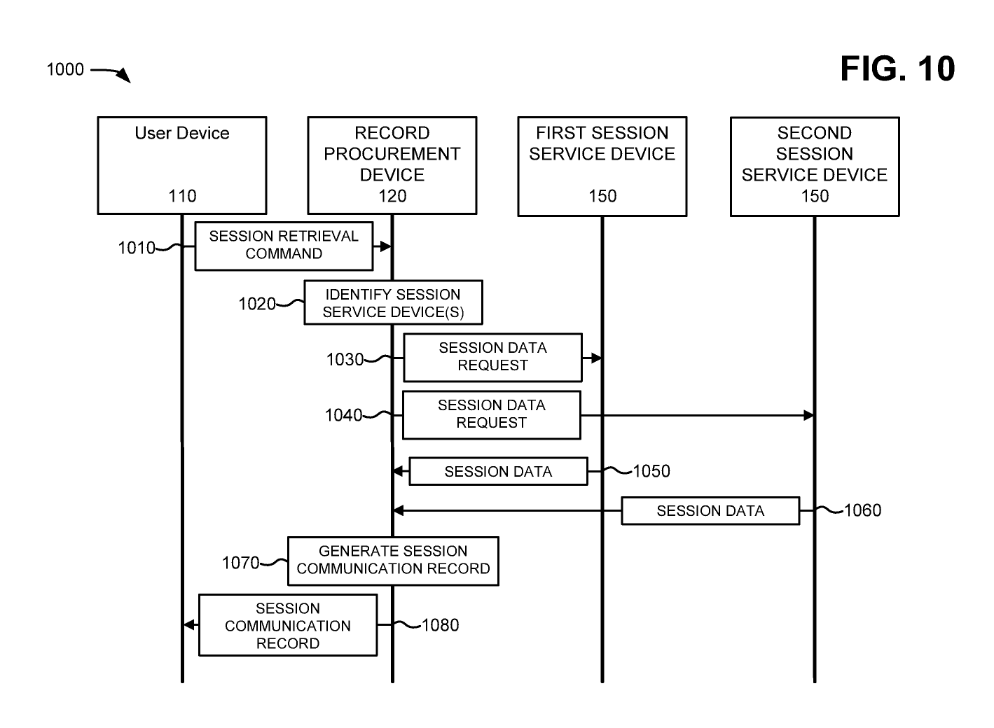

FIG. 10 is a sequence diagram of an example process 1000 for procuring a communication session record according to one or more implementations described herein. In one or more implementations, process 1000 may be performed by one or more components of user device 110, record procurement device 120, session metadata device 140, and/or session service devices 150. In other implementations, one or more blocks of process 1000 may be performed by one or more other components/devices, or a group of components/devices, including or excluding record user device 110, record procurement device 120, session metadata device 140, and/or session service devices 150.

User device 110 may communicate a session retrieval command to record procurement device 120 (block 1010). As discussed above, the retrieval command may correspond to one or more communication sessions represented by formatted session metadata provided to an operator of user device 110 (see, for example, FIG. 9, block 960 and 970). The session retrieval command may include a variety of information, such as one or more types of information that record procurement device 120 may use to identify a communication session and/or one or more session service devices 150 corresponding to the communication session (block 1020).

Record procurement device 120 may communicate a session data request to one or more session service devices 150 corresponding to the communication session associated with the session retrieval command (block 1030 and block 1040). The depicted example of FIG. 10 includes two session services devices 150. However, another example of one or more implementations discussed herein could include a single session service device 150 or more than two session service devices 150.

Each session service device 150 may respond to the session data requests by communicating session data to record procurement device 120 (block 1050 and block 1060). Record procurement device 120 may receive the session data and generate a session communication record based on the session data (block 1070). As discussed above, the session communication record may correspond to a complete record of the communication session requested in the session retrieval command. In some implementations, the record procurement device 120 may format the session communication record according to one or more of a variety of formats as discussed above with reference to FIG. 9. Record procurement device 120 may communicate the session communication record to user device 110 to enable an operator of user device 110 to, for example, review the session communication record and investigate one or more network conditions or operations relating to the session communication record.

While FIG. 10 shows a sequence of an example process 1000 for procuring a communication session record, in other implementations, a process for procuring a communication session record may include fewer devices or operations, different devices or operations, differently arranged devices or operations, or additional devices or operations than depicted in FIG. 10.

As described herein, devices may be used to procure communication session records. For example, session procurement device 120 may receive a session search command from a user via a user interface provided by session procurement device 120. The session search command may include a query for session metadata corresponding to search parameters provided by the user. Session procurement device 120 may communicate with session metadata device 140 to retrieve session metadata corresponding to the session search parameters, format the session metadata to represent one or more communication sessions, and provide the formatted session metadata to the user via the user interface.

In addition, session procurement device 120 may receive a session retrieval command corresponding to the session metadata provided to the user via a user interface. The session retrieval command may include a request for a communication session record corresponding to a communication session. Session procurement device 120 may identify, based on the session metadata, one or more service devices 150 that provided services to the communication session (e.g., a session setup device, a session IVR device, a session media device, etc.), and obtain session data from the session service devices. Session procurement device 120 may generate a communication session record based on the session data and provide the communication session record to the user via the user interface. The communication session record may include a text-based record of the communication session.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain implementations may involve a component that performs one or more functions. These components may include hardware, such as an ASIC or a FPGA, or a combination of hardware and software.

Even though particular combinations of features are recited in the claims and/or disclosed in the specification, these combinations are not intended to limit disclosure of the possible implementations. In fact, many of these features may be combined in ways not specifically recited in the claims and/or disclosed in the specification. Although each dependent claim listed below may directly depend on only one other claim, the disclosure of the implementations includes each dependent claim in combination with every other claim in the claim set.

No element, act, or instruction used in the present application should be construed as critical or essential to the implementations unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving, by a device, a session retrieval command corresponding to session metadata provided to a user via a user interface, the session retrieval command comprising a request for a communication session record corresponding to a communication session;
identifying, by the device, a first session service device, corresponding to the communication session, based on the session metadata, where the first session service device is to provide a first session service for communication sessions;
identifying, by the device, a second session service device, corresponding to the communication session, based on the session metadata, where the second session service device is to provide a second session service to communication sessions;
communicating, by the device, with the first session service device to obtain a first set of session data corresponding for the communication session;
communicating, by the device, with the second session service device to obtain a second set of session data corresponding to the communication session;
generating, by the device, a communication session record, corresponding to the communication session, based on the first set of session data and the second set of session data; and
providing, by the device, the communication session record to the user via the user interface.

2. The method of claim 1, where:
the first session service corresponds to a session setup service associated with the communication session, and
the second session service corresponds to an interactive voice response (IVR) service or a media service associated with the communication session.

3. The method of claim 1, further comprising:
communicating with a third session service device to obtain a third set of session data corresponding to the communication session, where the third session service device is to provide a third session service for communication sessions, where:
the first service, the second service, and the third service are different services, and
the communication session record is based the first set of session data, the second set of session data, and the third set of session data.

4. The method of claim 3, where:
the first session service corresponds to a session setup service associated with the communication session,
the second session service corresponds to an interactive voice response (IVR) service associated with the communication session, and
the third session service corresponds to a media service associated with the communication session.

5. The method of claim 1, further comprising:
providing the user interface to enable the user to input session search parameters;
receiving a session search command from the user, the session search command comprising a request to identify communication sessions corresponding to at least one session search parameter provided by the user;
communicating with a first session metadata device to retrieve a first set of session metadata corresponding to the at least one session search parameter; and
formatting the first set of session metadata to represent at least one first communication session record.

6. The method of claim 5, further comprising:
communicating with a second session metadata device to retrieve a second set of session metadata corresponding to the at least one session search parameter;
formatting the second set of session metadata to represent at least one second communication session record; and
providing the formatted session metadata to the user via the user interface.

7. The method of claim 5, further comprising:
communicating with a third session service device to obtain a third set of session data corresponding to the communication session, where the third session service device is to provide a third session service to communication sessions, where:
the first service, the second service, and the third service are different services, and
the communication session record is based the first set of session data, the second set of session data, and the third set of session data.

8. The method of claim 5, where the at least one session search parameter comprises at least one of a session identifier, a network node identifier, a session start time, a session end time, an application identifier, a network session identifier, a session initiation type, an IVR host identifier, a session exit type, a resource identifier, a selected portion of a protocol message, or a session leg identifier.

9. The method of claim 5, where:
the first session metadata device comprises a repository of session metadata corresponding to communication sessions supported by the first session service device or the second session service device.

10. A non-transitory computer-readable medium storing a program for causing a device to perform a method, the method comprising:
receiving, by a device, a session retrieval command corresponding to session metadata provided to a user via a user interface, the session retrieval command comprising a request for a communication session record corresponding to a communication session;
identifying a first session service device, corresponding to the communication session, based on the session retrieval command, where the first session service device is to provide a first session service for communication sessions;
communicating with the first session service device to obtain a first set of session data corresponding to the communication session;
generating a communication session record, corresponding to the communication session, based on the first set of session data; and
providing the communication session record to the user via the user interface.

11. The computer-readable medium of claim 10, where the first session service corresponds to:
a session setup service associated with the communication session, or
an interactive voice response (IVR) service associated with the communication session.

12. The computer-readable medium of claim 10, the method further comprising:
prior to the session metadata being provided to the user,
communicating with a second session service device to obtain a second set of session data corresponding to the communication session, where the second session service device is to provide a second session service to communication sessions, where:
the first session service and the second session service, and
the communication session record is based the first set of session data and the second set of session data.

13. The computer-readable medium of claim 12, where:
the first session service corresponds to at least one of:
a session setup service associated with the communication session,
an IVR service associated with the communication session, or
a media service associated with the communication session; and
the second session service corresponds to at least one of:
a session setup service associated with the communication session,
an IVR service associated with the communication session, or
a media service associated with the communication session.

14. The computer-readable medium of claim 10, the method further comprising:
providing the user interface to enable the user to input session search parameters;
receiving a session search command from the user, the session search command comprising a request to identify communication sessions corresponding to at least one session search parameter provided by the user;
communicating with a first session metadata device to retrieve a first set of session metadata corresponding to the at least one session search parameter;
formatting the first set of session metadata to represent at least one first communication session record; and
providing the formatted first set of session metadata to the user via the user interface.

15. The computer-readable medium of claim 14, the method further comprising:
communicating with a second session metadata device to retrieve a second set of session metadata corresponding to the at least one session search parameter;
formatting the second set of session metadata to represent at least one second communication session record; and
providing the formatted session metadata to the user via the user interface.

16. The computer-readable medium of claim 15, the method further comprising:
communicating with a second session service device to obtain a second set of session data corresponding to the communication session, where the second session service device is to provide a second session service communication sessions, where:
the first session service and the second session service are different services, and
the communication session record is based the first set of session data and the second set of session data.

17. The computer-readable medium of claim 14, where the at least one session search parameter comprises at least one of a session identifier, a network node identifier, a session start time, a session end time, an application identifier, a network session identifier, a session initiation type, an IVR host identifier, a session exit type, resource identifier, a selected portion of a protocol message, or a session leg identifier.

18. The computer-readable medium of claim 10, where the first session metadata device comprises a repository of session metadata corresponding to communication sessions supported by the first session service device.

19. An apparatus, comprising:
a memory for storing instructions; and
a processor, connected to the memory, to:
receive a session retrieval command comprising a request for a communication session record corresponding to a communication session;
identify a first session service device, corresponding to the communication session, based on the session retrieval command, where the first session service device is to provide a first session service for communication sessions;
identify a second session service device, corresponding to the communication session, based on the session retrieval command, where the second session service device is to provide a second session service for communication sessions,
where the first session service and the second session service are different services;
communicate with the first session service device to obtain a first set of session data corresponding to the communication session;
communicate with the second session service device to obtain a second set of session data corresponding to the communication session;
generate a communication session record, corresponding to the communication session, based on the first set of session data and the second set of session data; and
provide the communication session record to the user via the user interface.

20. The apparatus of claim 19, where generating the communication session record comprises creating a text-based record of the communication session that is consistent with a pre-selected format.

21. A system, comprising:
a client device;
a record procurement device;
a centralized session metadata storage; and
a plurality of session service systems,
where the record procurement device is to:
receive a session search command from the client device, the session search command comprising at least one session search parameter,
obtain session metadata, corresponding to the at least one session search parameter, from the centralized session metadata storage, the session metadata comprising information descriptive of at least one communication session, and
format the session metadata to represent at least one communication session and provide the session metadata to the client device,
receive a session retrieval command from the client device, the session retrieval command comprising a request to retrieve a communication session corresponding to the at least one communication session,
identify at least one of the plurality of service systems 130 that corresponds to the at least one communication session based on the session metadata used to represent the at least one communication session,
retrieve session data, corresponding to the at least one communication session, from the at least one session service system, and
generate a communication session record based on the session data corresponding to the at least one communication session.

22. The system of claim 21, where, to retrieve the session data, the record procurement device is to:
retrieve session data from a plurality of session service devices corresponding to the at least one session service system, where each of the plurality of session service devices is arranged to provide a different communication session service.
